(19) United States
(12) Patent Application Publication
(10) Pub. No.: US 2019/0308474 A1
(43) Pub. Date: Oct. 10, 2019

(54) ROLLING PONTOONS AND THEIR USE ON AMPHIBIOUS VEHICLES AND WATERCRAFT

(71) Applicant: MAITHEW LEE TOWNE, OVIEDO, FL (US)

(72) Inventor: MATTHEW LEE TOWNE, OVIEDO, FL (US)

(21) Appl. No.: 15/949,001

(22) Filed: Apr. 9, 2018

(51) Int. Cl. B60F 3/00; B63H 5/02

(52) U.S. Cl. CPC B60F 3/0007; B63H 5/02; B60F 3/0038

(57) ABSTRACT

A plurality of rolling pontoons with or without a plurality of protrusions (paddles) and their use on amphibious vehicles and watercraft. The application of tires, power, suspension, paddle designs, towing apparatus, pontoon geometry and/or a plurality pontoon arrangements that will allow said vehicle to be towed without a trailer, easily and quickly traverse a variety of environments, and/or maneuver a variety ways. The further addition of electric motors, solar panels, and batteries allow efficient electric amphibious vehicle/watercraft and provide battery backup and power for a residence. A method of manufacture is defined with the modular application of said electrical drivetrain to new or existing amphibious vehicles or watercraft.

### FIELD OF THE INVENTION

The present invention relates to the novel design and method of use of pontoons for amphibious vehicles and/or water craft. More specifically the invention relates to the design and use of pontoons on amphibious vehicles to allow efficient launching, beaching, traction, transfer/regeneration of motive/electrical energy, vehicle storage and trailerless towing.

### BACKGROUND

Historically, boating enthusiasts have often experienced difficulty with energy efficient aqueous traction, launching, towing, storing, shallow waters and beaching their boats.

Traditional traction and motive energy transfer for watercraft consists of hulls with propellers, waterjets, sails and/or paddlewheels. While effective, these configurations are typically inefficient and may also be inefficient for the regeneration of energy as commonly done with electric cars. The reason this is inefficient for the regeneration of energy is most of the energy is used or dissipated by the movement of the hull through and/or on the water. These inefficiencies pose a need for a more efficient and sustainable solution for the transfer and regeneration of energy with watercraft.

Current amphibious vehicles address many of the difficulties of launching, beaching and traversing shallow waters. The current art incorporates wheels and/or tracks. While the current art works well for land they are typically slow, inefficient and/or ugly in the water. The current represents a need for a more efficient and elegant way of traversing both water and land.

The incorporation of wheels on watercraft for towing and/or launching without the need or storage of a trailer is evident by the current art. The addition of these wheels for trailerless boats are usually unsightly and/or inefficient. The current art is in need of a solution that maintains or increases efficiency while improving aesthetics and eliminating the need for a trailer.

Launching a watercraft has traditionally required significant effort, time, and ramp availability. Busy water bodies can experience heavy congestion and frustration at boat ramps. Also known as ramp rage. In addition correctly maneuvering a boat onto a trailer can be difficult, time consuming and dangerous. Not to mention the parking of the trailer while the boat is on the water can also be an issue. These difficulties raise a need for a more efficient way to launch a boat and eliminate the need for storing a trailer while in the water.

The current art for storing boats includes boat houses, trailers and simply leaving the boat in the water. Boat houses and trailers both get the boat out of the water which helps preserve the boat. Leaving the boat in the water can cause premature wear and requires more maintenance. Generally these solutions require additional hardware, time and cost. There is a need for a solution that would easily get the boat out of the water and wouldn't require any additional hardware or cost.

It is the object of the present invention to provide for a more efficient solution for the transfer and regeneration of energy with watercraft. Another object of the present invention is a more efficient way of traction for both water and land for watercraft and/or amphibious vehicles. Another object of the present invention is to eliminate the need for a boat trailer while maintaining or increasing aquatic efficiency. Another object of the present invention is to allow the water craft to easily enter and leave the water. These and other objects of the invention will be apparent to those skilled in the current art from the summary that follows.

### BRIEF SUMMARY OF VARIOUS EMBODIMENTS OF THE INVENTION

The present invention consists of the novel design and use of transversely mounted pontoons that provide buoyancy, traction and/or steering for an amphibious vehicle and/or watercraft. The pontoons may be fitted with road tires and/or protrusions for traction on land and water respectively. These pontoons with fittings will allow a vehicle to efficiently traverse water, snow, ice, mud, land, roads, and/or to be towed on land without a trailer.

Various embodiments of the invention involve various quantities and arrangements of pontoons on an amphibious vehicle and/or watercraft. More specifically these pluralities include, but aren't limited to, the incorporation of a single pontoon to the entire hull being comprised of pontoons. These embodiments are based on, but not limited to, the need for traction, buoyancy and/or maneuvering.

Various embodiments of the invention have to do with the incorporation of protrusions to the pontoons for water and land traction. More specifically one embodiment uses a tire like embodiment with protrusions to not only give traction but protect the pontoon. Other embodiments incorporate, but aren't limited to, protrusions incorporated directly into, or varying the shape of the the pontoon itself.

Various embodiments of the invention incorporate a conventional road tire to give better traction when traversing roads and towing. Various quantities and/or arrangements pontoons and tires may be incorporated in various embodiments.

### BRIEF DESCRIPTION OF THE DRAWINGS

Some embodiments of the current invention are illustrated and not limited by the figures in the appended drawings, in which like references may indicate similar elements: The hull and deck shown in the following figures are included only to show the incorporation/orientation and/or method of use with relation to a watercraft and are not intended to detail the design of the invention.

FIG. 1 Is a top view perspective of one embodiment of a sample amphibious watercraft with transverse rolling pontoons. This perspective is provided to give a complete view of one embodiment of the invention and its method of use with respect to a watercrafts deck and hull.

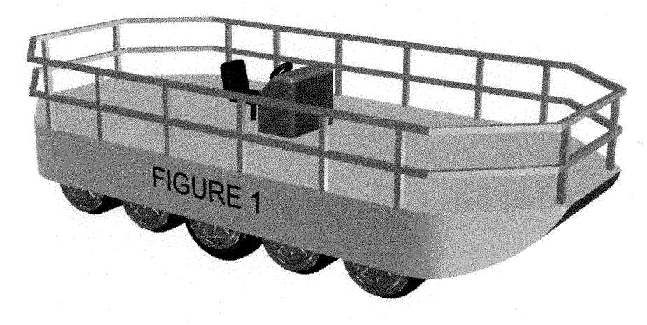

FIG. 2 Is a bottom view perspective of one embodiment of the invention. This embodiment shows the pontoon design and method of use (but not limited to) for buoyant and limited amphibious use. This embodiment allows for easy beaching, unbeaching, traversing shallow water and limited land travel.

FIG. 3 Is a bottom view perspective of one embodiment of the invention. This embodiment shows the pontoon design and method of use for (but not limited to) buoyancy, traction and maneuvering with respect to a conventionally hulled watercraft.

FIG. 4 Is a bottom view perspective of one embodiment of the invention. This embodiment shows the pontoon design and method of use for (but not limited to) buoyancy, traction and maneuvering with respect to a traditional pontoon or catamaran style watercraft.

FIG. 5 Is a bottom view perspective of one embodiment of the invention. This embodiment shows another possible design and method of use for (but not limited to) buoyant, traction and maneuvering for a traditional pontoon boat or catamaran style watercraft.

FIG. 6 Is a bottom view perspective of one embodiment of the invention. This embodiment shows the pontoon design and method of use for (but not limited to) buoyancy, traction and maneuvering with respect to a watercraft. This method of use is preferred and incorporates the pontoons as the primary hull of the vehicle.

FIG. 7 is a top view perspective of a complete embodiment of the pontoon with water traction protrusions(paddles) and a road tire.

FIG. 8 is a top view perspective of an exploded embodiment of the pontoon with water traction protrusions (paddles) and a road tire.

FIG. 9 is a top view perspective of an exploded embodiment of the pontoon with another possible embodiment of water traction protrusions (paddles) and a road tire.

FIG. 10 Is a side view of one embodiment of the amphibious watercraft. The purpose of this view is to illustrate one embodiment of the towing features of pontoons fitted with road/tow tires.

FIG. 11 Is a top view perspective of one embodiment of the pontoons incorporated into a modular chassis.

FIG. 12 Is is a top view perspective of an embodiment of a complete drive module from the modular chassis in FIG. 11.

FIG. 13 Is an exploded top view perspective of the drive unit in FIG. 12. This view does not show a portion of the chassis frame for clarity

FIG. 14 Is a top view perspective of one embodiment of a sample amphibious watercraft with transverse rolling pontoons.

FIG. 15 Is a bottom view of one embodiment of the invention showing one possible method of use of conical rolling pontoons.

FIG. 16 Is a perspective view of one embodiment of the invention showing the incorporation of solar panels on the vehicle.

FIG. 17 Is a perspective view of one embodiment of the invention showing 2 rolling pontoons with angled protrusions.

FIG. 18 Is a perspective view of one embodiment of the vehicle showing the pontoons with a flexible connection (suspension) to the vehicle chassis.

### DETAILED DESCRIPTION OF VARIOUS EMBODIMENTS OF THE INVENTION

The terminology used herein is for the purpose of describing particular embodiments and is not intended to be limiting of the invention. As used herein, the term “and/or” includes any and all combinations of one or more of the associated listed items. As used herein, the singular forms “a”, “and”, and “the” intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and\or groups thereof. As used herein the word “Paddles” can include any protrusion for the traction of water.

Unless otherwise defined, terms (including technical and specific terms) used herein have the same meaning as commonly understood by one having ordinary skill in the current art to which this invention belongs. It will be further understood that terms, such as those defined in commonly used dictionaries, should be interpreted as having a meaning that is consistent with their meaning in the context of the relevant current art and the present disclosure and will not be interpreted in an idealized or overly formal sense unless expressly so defined herein.

In describing the invention it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the current art that the present invention may be practiced without these specific details

The present invention will be described by referencing the appended figures representing the various embodiments.

Various embodiments of the invention are presented but not limited to the following. Various embodiments of the pontoons are fitted with (but not limited to) axle(s) and oriented transversely to allow the pontoons to connect to the watercraft and to roll across water and land. Various embodiments of the invention may attach to fixed, independent or various other types of suspensions that then attach to the chassis. The preferred embodiment uses, but is not limited to, attachments and/or axles at, but not limited to, each end of each pontoon to attach to the chassis and/or suspension. Various embodiments generally use, but are not limited to, a transverse pontoon axis angle of 90° from the direction of travel. Preferred embodiments of pontoons use, but aren't limited to, 2 separate pontoons on the same axis. Various embodiments shown use, but aren't limited to, rectangular array arrangements of pontoons. Many different arrangements including, but not limited to, circular, triangular or other arrangements may be represented by different embodiments. Preferred embodiments are, but aren't limited to, cylindrical pontoons. Various embodiments may use, but aren't limited to conical or other shaped pontoons. Various embodiments incorporate, but aren't limited to, protrusions incorporated directly into, or varying the shape of the the pontoon itself. Various embodiments of pontoons may be, but aren't limited to, filled with gas, pressurized gas or buoyant solids. The preferred, but not limited to, material for the pontoons is aluminum. The preferred, but not limited to, material embodiment of tire protrusions would be rubber. Various embodiments of the tire protrusion, tow tire, and/or road tire embodiments may use, but aren't limited to, solid or gas filled tires. The protrusion tire, road tire, and tow tire are current preferred embodiments may use, but aren't limited to, conventional tire mounting methods and gaseous inflation methods and hardware.

Different embodiments of the design and method of use are, but not limited to, the following.

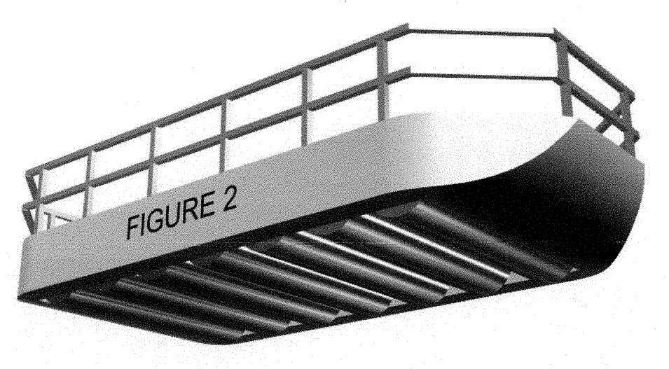

### 1. Pontoon Amphibious Design and Method of Use—See FIG. 2

Transversely mounted rolling pontoons that allow a watercraft to easily be beached, unbeached and\or traverse shallow water. In this embodiment the pontoons would comprise a significant portion of the vehicles buoyant hull. The pontoons would be the lowest point of the hull and oriented as to engage water bottoms or land before the hull.

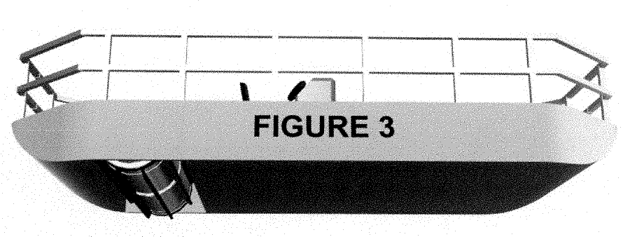

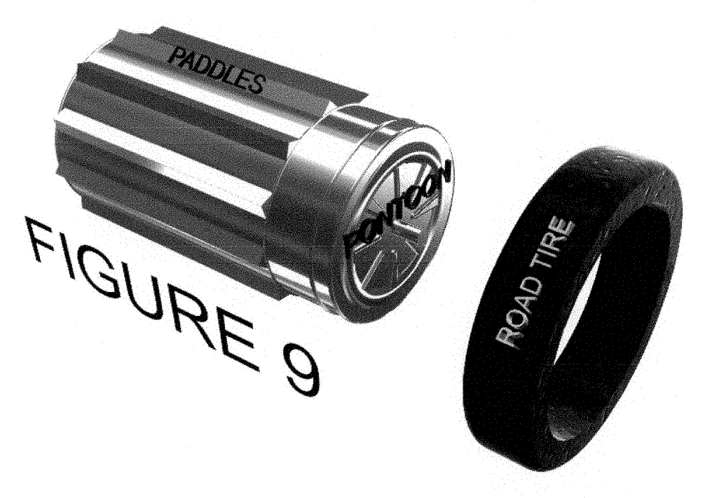

### 2. Pontoon Water Traction Design and Method of Use—See FIGS. 3, 4, 5, 6, 8 and 9

Transversely mounted rolling pontoon with protrusions that would allow a watercraft traction for transferring/regenerating motive/electrical energy, maneuvering and buoyancy.

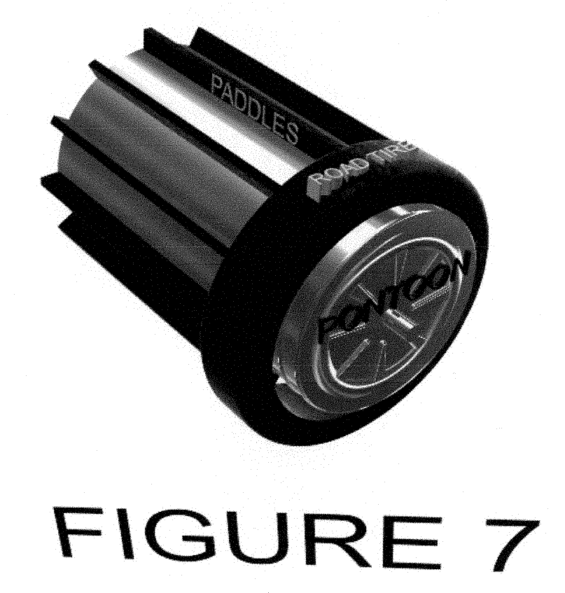

This embodiments protrusions would act similar, but not limited, to paddles on a traditional paddlewheel for water traction. This embodiment of the pontoon design would incorporate a plurality of protrusions that may be an integral part of the pontoon or be applied to the pontoon as would be a traditional tire. FIGS. 7, 8 and 9 show, but aren't limited to, several protrusion embodiments. The protrusion tire embodiment is currently preferred and would protect the pontoons while engaging water bottoms or land.

This embodiment shows (FIGS. 3, 4, 5 and 6), but is not limited to, two separate pontoons aligned along the same axis. The application of rotational power to the pontoons with differential speeds or direction and/or rotation of the two pontoons would allow the watercraft to maneuver and steer. The application of rotational power to the pontoons with parallel speeds and directions of rotation for both pontoons would allow the watercraft to travel forward or backward. Rotational power could be applied from a power source external to, or internal to the pontoons. The power source can include, but aren't limited to, electric motor, internal combustion engine and/or human power etc.

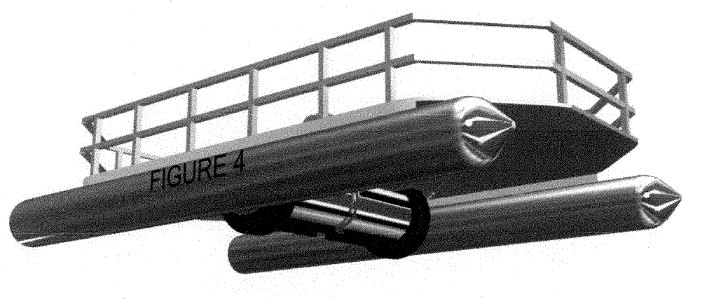

The pontoon embodiments shown in FIGS. 3 and 4 would comprise a small portion of the watercrafts buoyancy and/or hull.

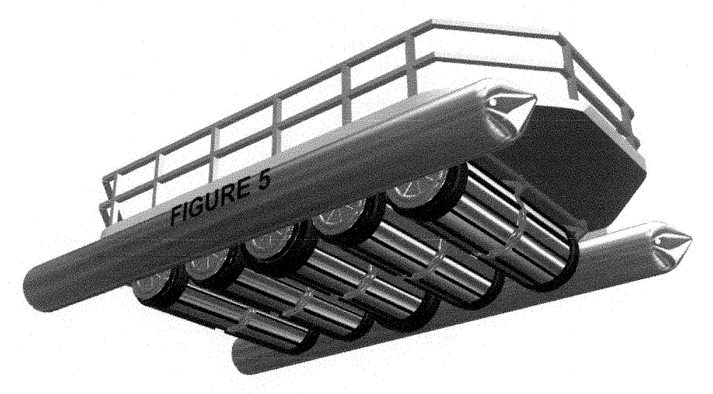

The pontoon embodiments shown in FIG. 5 would comprise a large portion of the watercrafts buoyancy and/or hull.

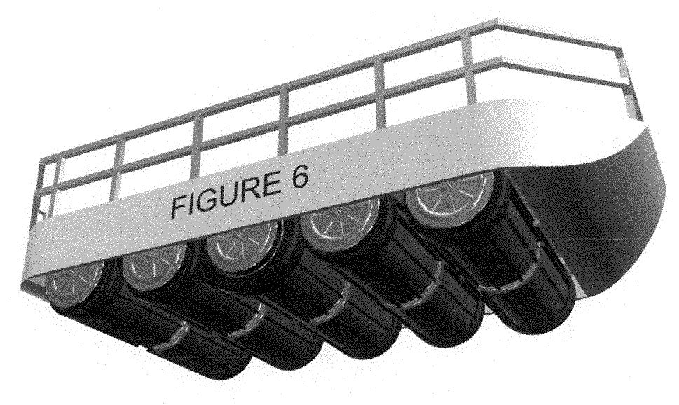

The pontoon embodiment shown in FIG. 6 would comprise all of the watercrafts buoyancy and/or hull. This is the preferred method for providing the most efficient traction use for the transfer of motive/electrical power to and from the water in a watercraft application.

### 3. Pontoon Road Traction Design and Method of Use—See FIGS. 5 and 6

Transversely mounted rolling pontoons with road tires that would allow a watercraft traction for improved transferring/regenerating of motive/electrical energy, buoyancy and maneuvering on land. This embodiment would incorporate a plurality of tires, pontoons, and tire mounting locations to insure vehicle stability and traction.

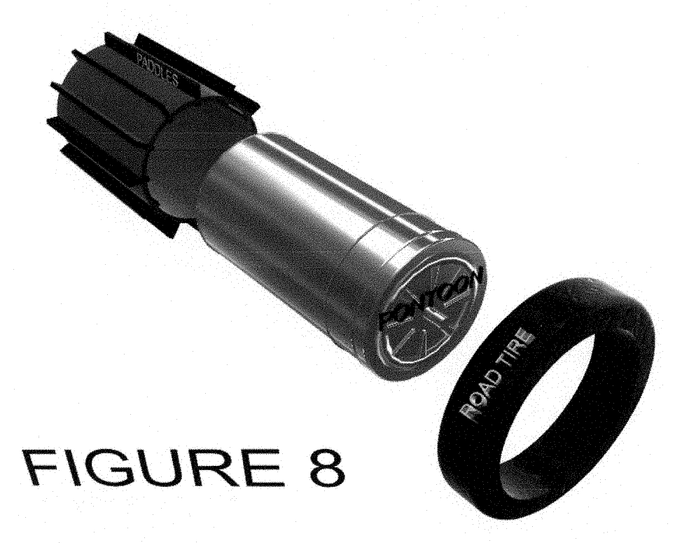

The embodiments shown in FIGS. 5 and 6 show road tires on pontoons (see FIGS. 7 and 8 also). The preferred embodiment has the road tire mounted as close to the edges of the watercraft to provide stability when on land.

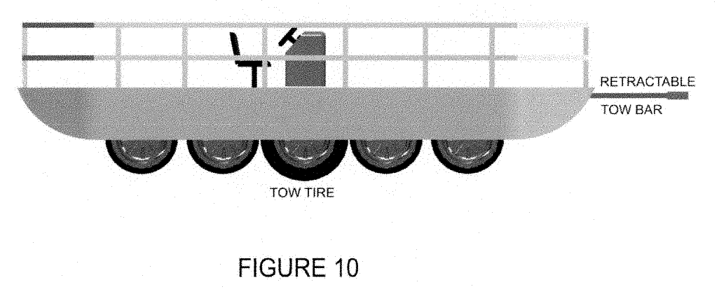

### 4. Pontoon Towing Design and Method of Use—See FIG. 10

Transversely mounted rolling pontoons with using road tires in combination with a tow bar that would allow a watercraft to be towed without a trailer on land.

This embodiment can also include, but is not limited to, two pontoons oriented along the same axis to allow differential rotation of the tires when on land.

The special road tires will herein be referred to as “tow” tires. This embodiment represents, but not limited to, a tow tire on each side of the vehicle. The tow tire would be mounted on the pontoons. Additional tow tires may be added on each side to allow towing of larger vehicles.

The tow tire would typically be a higher profile (FIG. 10) than the other road tires on other pontoons to provide clearance of the other road tires and/or for graceful turns while towing. In some embodiments like, but not limited to, FIGS. 3 and 4 the higher profile tow tire might also be needed for sufficient hull clearance when towing. This higher profile can be obtained by larger diameter tires than the other pontoon road tires or use of a collapsible road tire. A larger diameter tow tire with a fixed height would cause more drag in the water. The preferred mode would be to use a conventional collapsible tow tire, as used with a typical automotive spare tire, as this would allow the tire to be collapsed to that of the other pontoon tires and/or traction protrusions. The option to collapse the tire would provide better efficiency when on water.

The tow bar would typically be used on larger watercraft for towing by a land vehicle. Smaller watercraft such as, but not limited to, pedal powered paddle boats may not need any additional appendage to be manually towed on land. The tow bar could be a part of the chassis that the pontoons are attached to or incorporated into the boat itself.

The capacity for towing a watercraft is available for embodiments of the invention when used with an appropriately designed watercraft.

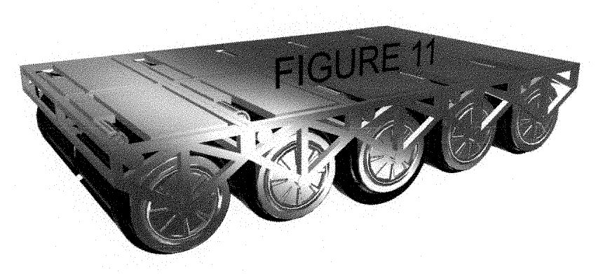

### FIGS. 11 Thru 13

FIG. 11 represents, but not limited to, one embodiment of a possible vehicle skateboard. This skateboard is comprised of a plurality of drive units that can be combined in a plurality of arrangements to accommodate a plurality of purposes. This skateboard could accommodate a variety of hull and deck combinations.

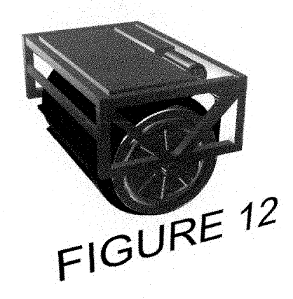

FIG. 12 represents a, but not limited to, embodiment of a single complete drive unit.

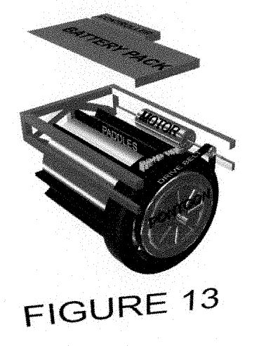

FIG. 13 represent a, but not limited to, exploded embodiment of a single drive unit, its components, and arrangement. This drive unit shows, but is not limited to, an electrical configuration.

### CONCLUSION

Although this invention has been described in specific detail with reference to the disclosed embodiments, it will be understood that many variations and modifications may be affected within the spirit and scope of the invention as described in the claims filed with the non-provisional application.

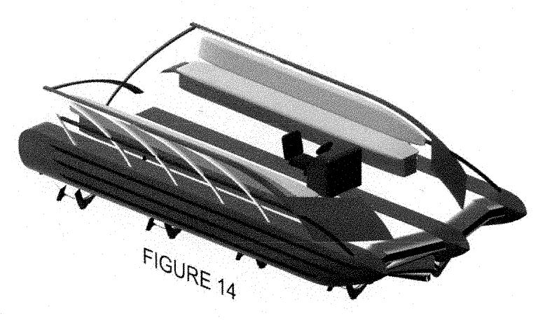

### Additional Watercraft Embodiment—FIG. 14

This figure shows the perspective view of an additional embodiment using, but not limited to, cone shaped paddlewheel pontoons along with varying pontoon diameters and arrangements.

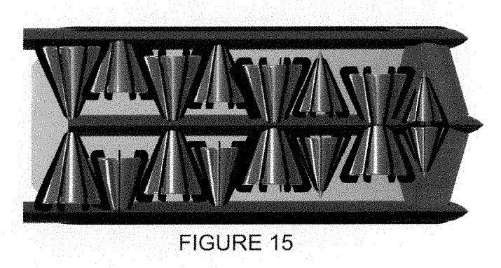

### Pontoon Diameter Embodiment—FIG. 15

This figure shows the side profile of the watercraft from FIG. 14 in profile. This embodiment shows, but is not limited to, the diameters of the inner pontoons increasing as the pontoons get closer to the rear of the craft. The purpose of the varying diameters is to, but not limited to, help efficiency and effectiveness at different speeds and loading.

FIG. 15 further shows, but is not limited to, a possible arrangement of pontoons. This arrangement includes offsetting cone shaped pontoons along with moving the pontoons outward as you move towards the rear of the vehicle. The purpose of this configuration is, but isn't limited to, is to provide better control and stability of the vehicle at high speeds.

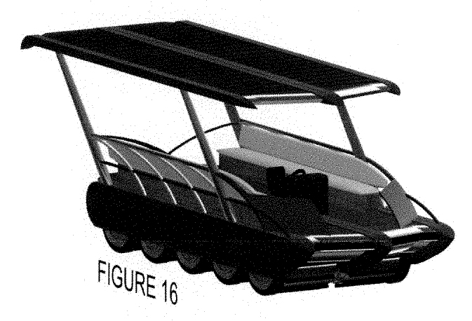

### Solar Panel Embodiment—FIG. 16

This figure shows a perspective view of another embodiment of an amphibious vehicle or watercraft. This embodiment uses, but is not limited to, cylindrical pontoons with a solar bmini. The purpose of the solar bimini is, but not limited to, provide electrical energy to the electric motors, an alternating current converter, the electrical grid, a house and/or batteries.

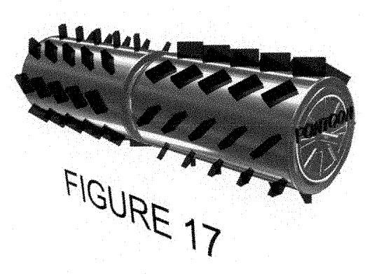

### Angle Protrusion Pontoon Embodiment—FIG. 17

This figure shows a perspective view of an embodiment of 2 rolling pontoons with angled protrusions. This embodiment allows the rolling pontoons to provide a wide range of motion when mounted to a vehicle and differential rotational speeds and/or directions are applied.

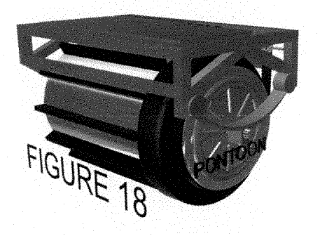

### Pontoon Suspension Embodiment—FIG. 18

This figure shows a perspective view of a modular chassis with a flexible connection to the chassis such as a typical land vehicle suspension. This embodiment will allow, but is not limited to, better towing, driving on hard surfaces and minimizing wave actions while on the water.

1. A rolling pontoon comprising an axis of rotation that has a transverse orientation to the direction of travel.

2. The rolling pontoons of claim 1 wherein: one or more pontoons on and measured along the same rotational axes; are greater than the average diameter of said pontoons on said rotational axis.

3. The rolling pontoons of claim 2 wherein: one or more pontoons on and measured along the same rotational axes; are greater than ½ of the vehicle width as measured along said rotational axis.

4. The rolling pontoons of claim 3 further comprising: of protrusions (paddles) as part of said rolling pontoons; or as one or more attachments such as tires to said rolling pontoons.

5. The rolling pontoons of claim 4 further comprising of protrusions that are angled from the direction of travel (not parallel or perpendicular) where said protrusions are typically perpendicular to the direction such as a typical paddlewheel.

6. The rolling pontoons of claim 4 further comprising of one or more road tires mounted on same rotational axis as said pontoons.

7. The rolling pontoons of claim 4 wherein said pontoons further comprise of radial shapes such as cylinders or discs or cones or bells or eggs or stars or helixes that rotate about the center of said radial shape.

8. A amphibious vehicle or watercraft comprising of a chassis with transversely oriented rolling pontoons of claim 3 mounted to said chassis.

9. The amphibious vehicle or watercraft and rolling pontoons of claim 8 further comprising the application of rotational energy such as electric motors or internal combustion engines connected to said rolling pontoons.

10. The amphibious vehicle or watercraft of claim 9 further comprising of electrical energy storage devices such as batteries or fuel cells affixed to chassis and electrically connected to said motors and engines.

11. The amphibious vehicle or watercraft of claim 10 further comprising of a method of use where: the rolling pontoons with angled protrusions (paddles) of claim 5; while in contact with a surface; and applying differential rotational speeds and/or directions to 1 or more said rolling pontoons with said angled protrusions;
whereby said vehicle will have a range of motion relative to said surface that is perpendicular to parallel of the axis of pontoon rotation.

12. The amphibious vehicle or watercraft of claim 10 further comprising of rolling pontoons attached with a solid connection to the chassis (no suspension).

13. The amphibious vehicle or watercraft of claim 10 further comprising of rolling pontoons attached to the chassis with a flexible connection such as a typical automobile suspension.

14. A method of use for the amphibious vehicle or watercraft with rolling pontoons of claim 10 further comprising: said vehicle with said pontoons rolling across a surface which is in motion relative to the amphibious vehicle or watercraft: and the rolling pontoons are connected to an electrical generator or motor; and said motors or generators electrical output is connected to an electrical storage device such as a battery; and whereby electrical energy from said motor is stored in said electrical storage device.

15. The amphibious vehicle or watercraft with rolling pontoons of claim 10 further comprising of 2 or more pontoons where locating and mounting said pontoons to said chassis along the direction of travel of said vehicle are closer to the center of said chassis than the front or rear of said chassis such as a typical trailer wheel arrangement.

16. The amphibious vehicle or watercraft of claim 10 wherein said rolling pontoons are mounted closer to the outside corners of said chassis than the center of said chassis such as a typical land vehicle wheel arrangement.

17. The amphibious vehicle or watercraft of claim 10 further comprising of a retractable, removable, or fixed towing apparatus attached to said chassis.

18. The amphibious vehicle or watercraft of claim 10 further comprising of 2 or more transversely oriented pontoons mounted to said chassis.

19. The amphibious vehicle or watercraft of claim 10 further comprising of solar panels mounted to said chassis with electrical connections to said motors and said batteries.

20. The amphibious vehicle or watercraft of claim 19 further comprising of a direct current (DC) to alternating current (AC) converter mounted to said chassis and electrically connected to said solar panels, batteries and motors.

21. The amphibious vehicle or watercraft of claim 10 further comprising of a method of use where: two or more said rolling pontoons; with the application of differential rotational speeds and/or directions; when in contact with a surface; whereby the vehicle can change the direction of travel or steer along said surface.

22. The amphibious vehicle or watercraft of claim 10 further comprising of pontoons whose ends extend outward from forward mounted pontoons.

23. The amphibious vehicle or watercraft of claim 10 further comprising of pontoon arrangements whose diameters increase from forward mounted pontoons.

24. The amphibious vehicle or watercraft of claim 10 further comprising of a single rolling pontoon, battery, electric motor, electric motor controller with connecting wiring all attached to a chassis module such that multiple said chassis modules can be connected together.

25. The amphibious vehicle or watercraft with rolling pontoons of claim 10 further comprising of said rolling pontoons mounted to a sub chassis with a moveable attachment to said vehicle chassis that allows said rolling pontoons on said sub chassis to move forwards and backwards along said vehicle chassis.
